(19) United States
(12) Patent Application Publication
(10) Pub. No.: US 2002/0147783 A1
(43) Pub. Date: Oct. 10, 2002

(54) Method, device and e-mail server for detecting an undesired e-mail

(75) Inventor: Rainer Kuth, Herzogenaurach (DE)

Correspondence Address: YOUNG & THOMPSON, 745 SOUTH 23RD STREET 2ND FLOOR, ARLINGTON, VA, 22202

(73) Assignee: SIEMENS AKTIENGESELLSCHAFT, MUNCHEN (DE)

(21) Appl. No.: 10/108,632

(22) Filed: Mar. 29, 2002

(30) Foreign Application Priority Data
Mar. 29, 2001 (DE) 101 15 428.3

(51) Int. Cl. G06F 15/16

(52) U.S. Cl. 709/207

(57) ABSTRACT

The invention relates to a method, a device and an e-mail server (21) for detecting an undesired e-mail (300) before an addressee (27-31) of the undesired e-mail (300) reads the undesired e-mail (300). For the method, a first e-mail (300) which is intended for the addressee (27-31) is evaluated with at least one predetermined criterion before the addressee (27-31) reads the first e-mail (300). On the basis of the evaluation, a second e-mail (400, 500) with the notification that there is a possibly undesired e-mail for the addressee (27-31) is automatically generated and sent to the addressee (27-31) of the first e-mail (300).

### DESCRIPTION

The invention relates to a method, a device and an e-mail server for detecting an undesired e-mail before an addressee of the undesired e-mail reads it.

People unfortunately often receive undesired e-mail, for example an advertising e-mail or an e-mail containing a computer virus. The advertising e-mail is of course only a nuisance and wastes valuable working time if it is read during working time. However, e-mails containing a computer virus can cause damage to hardware and software of the computer when in the first instance they are downloaded by a computer from a mail server storing the e-mail and opened for reading.

There are of course what are referred to as virus scanners, that is to say computer programs which examine e-mails for computer viruses and which make detected computer viruses harmless. However, known virus scanners can only identify known computer viruses. It is also the case that virus scanners do not discover annoying advertising e-mails.

U.S. Pat. No. 6,023,723 discloses a method for automatically detecting and deleting undesired e-mails. Each incoming e-mail is checked to determine whether it originates from an undesired or a desired sender. This information is contained in corresponding lists. If an e-mail originates from an undesired sender it is automatically deleted before the addressee can read it. If the e-mail originates from a desired sender, it is passed on to the inbox of the addressee. If the e-mail originates neither from a desired sender nor from an undesired sender, it is directed into a separate, specially designated file which the addressee can open.

U.S. Pat. No. 5,999,932 discloses a method which automatically categorizes e-mails into desired, potentially interesting and undesired e-mails and appropriately designates them. An e-mail is detected as being desired if data from filled-in fields of the e-mail, for example the address or the reference field of the e-mail, corresponds to data stored in a list. The e-mail is then designated, for example, as “OK”. If the data of the field does not correspond to the data stored in the list, the e-mail is evaluated with predefined criteria and evaluated as potentially interesting or as undesired in accordance with the evaluation. A potentially interesting e-mail is designated, for example as “NEW” and an undesired e-mail as “JUNK”.

U.S. Pat. No. 6,052,709 discloses a system for monitoring junk mail. The system comprises a communications network with a plurality of terminals to each of which an e-mail address is assigned, and a control center. The control center is embodied in such a way that it generates additional e-mail addresses and distributes them on the communications network. The additional e-mail addresses are not assigned to any specific person. If one of the additional e-mail addresses receives an e-mail, its sender data is extracted and stored in a database of the control center. Filters which are stored on the terminals are then modified in such a way that each terminal detects when it receives an e-mail from the sender who has previously sent an e-mail to one of the additional e-mail addresses.

U.S. Pat. No. 6,112,227 describes a further method which is intended to be used to prevent the reception of undesired e-mails. If an e-mail server receives an e-mail, it determines whether the sender of the e-mail is registered before it passes on the e-mail to the client to which the e-mail is addressed. If the sender is not registered, the e-mail server sends a registration form to the sender of the e-mail in order to register said sender. After the registration, it passes on the e-mail to the client to which the e-mail is addressed.

A further method for classifying e-mails into desired and undesired e-mails is disclosed in U.S. Pat. No. 6,161,130. The contents of a received e-mail are checked automatically for predetermined words or phrases. Then, it is automatically determined whether the e-mail is undesired or desired on the basis of found words or phrases and on the basis of probability; the e-mail is then directed into corresponding files. If the addressee classifies an e-mail differently, as can occur as a result of the automatic classification, the probabilities for automatic classification are re-determined.

By means of the computer program disclosed in U.S. Pat. No. 6,167,434, it is made easier for an addressee of a spam mail to delete himself from a sender list of the sender of the spam mail. The computer program is embodied in such a way that, after the addressee of the spam mail has deleted this mail, an e-mail is automatically sent to the sender of the spam mail. The e-mail comprises a request to delete the addressee from the sender's list.

U.S. Pat. No. 6,199,103 B1 discloses a method for determining criteria for identifying a junk mail. A received e-mail is detected as junk mail by means of known criteria. The junk mail is then stored and its contents analyzed to determine whether it contains further suitable criteria for detecting the junk mail. If the junk mail contains further suitable criteria, they are added to the already known criteria.

GB 2 350 747 A discloses a method for preventing undesired e-mails addressed to a network. A subscriber to the network receives an e-mail and categorizes it as undesired. It is then checked whether the subscriber, or further subscribers of the network, receive at least similar e-mails. Suitable countermeasures are initiated on the basis of the check.

On the basis of the method proposed in WO 00/49776, e-mails sent by a server are directed to a proxy host which filters out junk mails before passing on the e-mails to the corresponding client. The proxy host can be embodied in such a way that it passes on filtered-out junk mails to an administrator, via a secure World Wide Web document, so that the administrator can check them.

WO 01/16695 A1 proposes that only e-mails which originate from predetermined senders should be passed on from the server to the addressee. If the server receives an e-mail which does not originate from one of the predetermined senders, the sender is requested to prove his authorization. If the sender proves his authorization within a predetermined time period, the e-mail is delivered to the addressee, otherwise it is automatically deleted.

JP 2000163341 A discloses a method in which an e-mail server extracts the sender and addressee of a received e-mail and automatically determines whether the e-mail is to be deleted. If the e-mail is automatically deleted, the sender of the e-mail automatically has a notification e-mail sent to him with which he is informed of the deletion of the received e-mail and the reasons for the automatic deletion.

JP 2000339236 A describes a method on the basis of which the sender of a received e-mail is extracted and compared with senders from a list. If the sender is contained in the list, the e-mail is automatically deleted, a notification e-mail is sent to the sender or the e-mail is designated for the addressee.

The object of the invention is therefore to specify a method which brings about conditions for eliminating undesired e-mails before they can cause damage. Further objects of the invention are to configure a device and an e-mail server in such a way that conditions are brought about for eliminating undesired e-mails before they can cause damage.

The first object is achieved according to the invention with a method for detecting a undesired e-mail, having the following method steps:

reception of a first e-mail sent to an addressee by means of an e-mail server,

automatic evaluation of the first e-mail with at least one predetermined criterion, and

automatic generation and transmission of a second e-mail, based on the evaluation of the first e-mail, to a computer of the addressee of the first e-mail with a notification that there is a possibly undesired e-mail for the addressee, before the first e-mail is passed on to the computer of the addressee.

An undesired e-mail is understood to be in particular, an e-mail containing a computer virus or what is referred to as a junk mail, for example an unsolicited advertising e-mail. The e-mail containing the computer virus can in the worst case lead to damage to a computer of the addressee or to damage to computer programs stored on this computer, while junk mails can unnecessarily waste working time.

According to the invention, the first e-mail is therefore evaluated according to at least one criterion before the addressee can read this e-mail, i.e. the first e-mail is evaluated before the addressee can download it from an e-mail server with his computer and open it, or before the e-mail server passes on the first e-mail to the computer of the addressee. The first e-mail is thus evaluated before it can cause damage. The evaluation of the first e-mail can be carried out, for example, by means of a computer program stored on the e-mail server.

A criterion for the evaluation of the first e-mail is according to one embodiment of the invention, for example, a number of further addressees to whom the first e-mail is also addressed. Junk mail or e-mail comprising a computer virus is per se sent to a large number of addressees in order, for example, to cause as much damage as possible. A large number of addressees of the same e-mail can therefore be a sign of an undesired e-mail.

A further sign for an undesired e-mail is that the addressee or the addressees repeatedly have the same e-mail sent to them in a relatively short time so that a sender of the e-mail increases his chance of the addressee or at least one of the addressees opening the e-mail and reading it. Therefore, a particularly preferred variant of the invention provides for the criterion to be a number of further e-mails which have been sent to the addressee or further addressees in a predefined time period and have the same reference as the first e-mail.

According to one variant of the invention, the criterion is a number of further e-mails which have the checksum of the data record of the reference and/or of the message as the first e-mail. The checksum is characterized in that a change in an individual bit in the entire data record, over which the checksum is formed, changes the checksum. This is achieved in that all the bytes of data record are summed. If the data records are transmitted using the 8 bit method, as, for example, in the ASCII format or in the extended ASCII format, the checksum corresponds to a number between 1 and 256. It changes as soon as one bit within the data record is different. That is to say two e-mails with the same message, that is to say two identical e-mails, have the same checksum of the data records of their messages.

After the evaluation of the e-mail, according to the invention a second e-mail is automatically sent, on the basis of the evaluation of the first e-mail, to the addressee with a notification that a possibly undesired e-mail has arrived at the e-mail server. This second e-mail is, for example, automatically generated by the e-mail server and automatically sent to the addressee. The notification can advantageously comprise the reference, the sender and the number of further addressees of the first e-mail. The addressee is warned by this second e-mail and can decide himself whether he wishes to download the first e-mail from the e-mail server, open it and read it.

According to another variant of the invention, there is provision for the first e-mail to be evaluated only if it has been sent by a computer which is connected outside a local computer network, the local computer network comprising a computer of the addressee and it being possible for said local computer network to be contacted by the computer from which the first e-mail was sent. The local computer network can be assigned, for example, to a company or to an official authority. e-mails which are sent within the local computer network are consequently not evaluated because it is improbable that they are junk mails or are provided with a computer virus. Thus, in particular e-mails which are directed to a relatively large group of addressees within the company or the official authority are sent without being evaluated.

The further object of the invention is achieved by a device for detecting an undesired e-mail before an addressee of the undesired e-mail reads the undesired e-mail, having

an e-mail server and

a computer which is connected to the e-mail server, for the purpose of reading e-mails which are intended for the addressee,

the e-mail server being embodied in such a way that it evaluates a first e-mail sent to the addressee, with at least one predetermined criterion, automatically generates a second e-mail on the basis of the evaluation of the first e-mail and sends said second e-mail to the computer of the addressee of the first e-mail before it passes on the first e-mail to the computer of the addressee, the second e-mail comprising a notification that there is a possibly undesired e-mail for the addressee.

Advantageous refinements of the device according to the invention emerge from the subclaims.

The further object is also achieved by means of an e-mail server which passes on e-mails which have been sent to an addressee to a computer of the addressee,

a computer program which evaluates a first e-mail sent to the addressee, with at least one predetermined criterion, running on the e-mail server, and

the e-mail server automatically generating a second e-mail on the basis of the evaluation of the first e-mail and sending said second e-mail to the computer of the addressee of the first e-mail, before it passes on the first e-mail to the computer of the addressee, the second e-mail comprising a notification that there is a possibly undesired e-mail for the addressee.

Advantageous refinements of the e-mail server according to the invention emerge from the subclaims.

An exemplary embodiment of the invention is illustrated by way of example in the appended schematic drawings, in which:

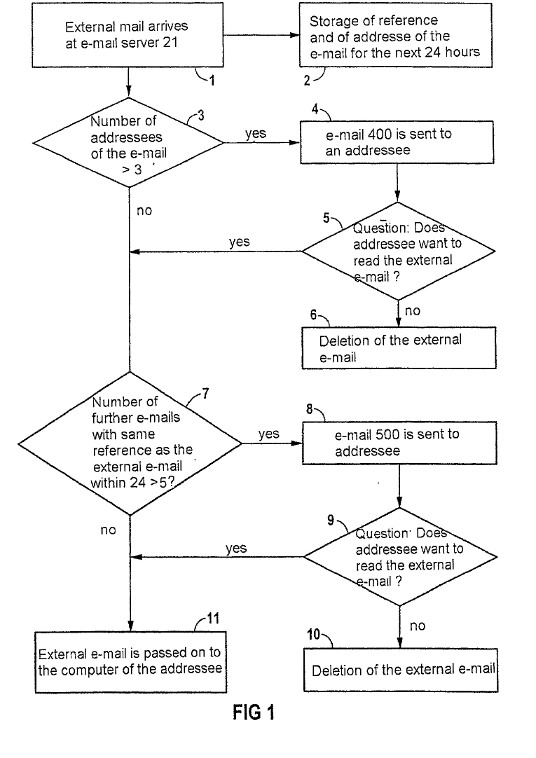

FIG. 1 shows a flowchart representing the method according to the invention,

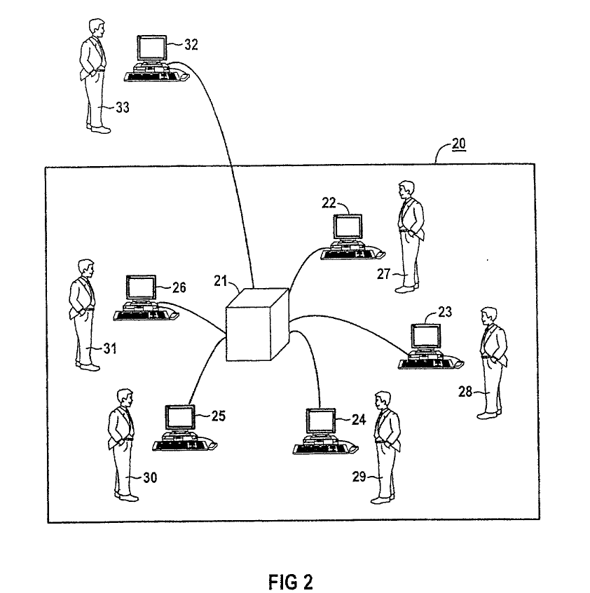

FIG. 2 shows a local computer network,

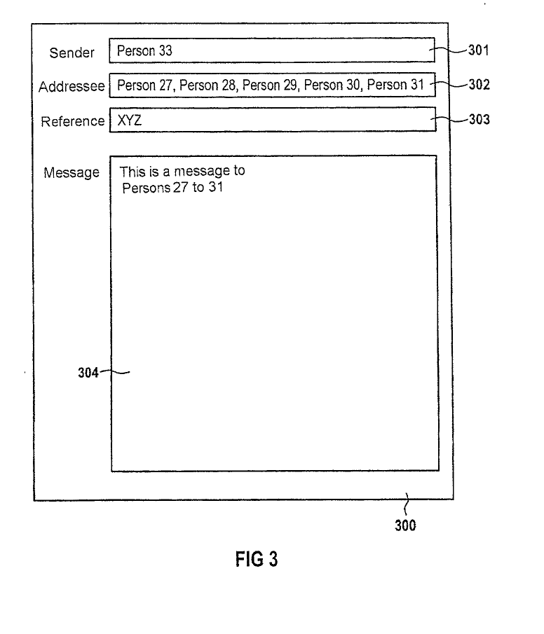

FIG. 3 shows a first e-mail and

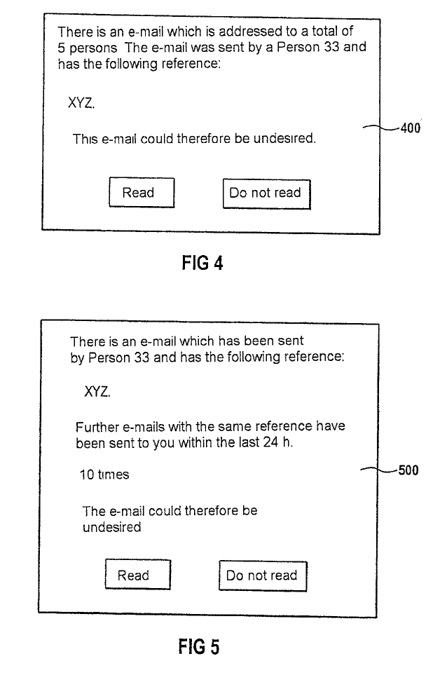

FIGS. 4 and 5 In each case show a second e-mail.

FIG. 1 shows a flowchart with steps 1 to 11 representing the method according to the invention which is explained in more detail by means of FIG. 2.

FIG. 2 shows a schematic, exemplary view of a local computer network 20 of an industrial company, which comprises an e-mail server 21 to which a plurality of computers 22 to 26 are connected. The e-mail server 21 can also be contacted by external computers, such as a computer 32 illustrated by way of example in FIG. 2, which is not part of the computer network 20. In this way, a person 33 can also use the computer 32 of one of the persons 27 to 31 to send an e-mail which the latter can read with one of the computers 22 to 26 of the computer network 20.

Before the persons 27 to 31 can read an e-mail addressed to them, said persons must request it from the e-mail server 21 using one of the computers 22 to 26 in a generally known way or the e-mail server 21 must pass on the corresponding e-mail to that computer of the computers 22 to 26 on which the respective person of persons 27 to 31 is currently working.

In the case of the present exemplary embodiment, the person 33 uses the computer 32 to send a first e-mail 300, comprising a computer virus, to the person 27 in order to damage the industrial company. This first e-mail 300 is therefore undesired and shown schematically in FIG. 3. In order to cause as much damage as possible, the person 33 also sends the same first e-mail 300 to the persons 28 to 31.

The first e-mail 300 which is shown in FIG. 3 has four fields 301 to 304 in the case of the present exemplary embodiment. The field 301 comprises an item of information on the sender of the first e-mail 300, that is to say the person 33, the field 302 comprises information on the addressee of the first e-mail 300, that is to say the persons 27 to 31, the 303 comprises a reference which is XYZ in the case of the present exemplary embodiment, and the field 304 comprises the message, that is to say the content of the first e-mail 300.

After the person 33 has dispatched the first e-mail 300 to the persons 27 to 31, it arrives at the e-mail server 21 (step 1 of the flowchart), which in the case of the present exemplary embodiment automatically stores the reference and the associated addressee or addressees of an e-mail sent by an external computer for the next 24 hours (step 2 of the flowchart), that is to say also the reference and the addressees of the first e-mail 300 sent by the person 33 using the computer 32.

In the case of the present exemplary embodiment, the e-mail server 21 automatically uses a suitable computer program stored in the e-mail server 21 to determine the number of addressees to which the same e-mail has been sent by an external computer. If this number is greater than three, the e-mail server 21 automatically generates a further e-mail and sends it to the addressee of the external e-mail (step 3 of the flowchart).

In the case of the present exemplary embodiment, the person 33 sent the same first e-mail 300 to the persons 27 to 31 and the number of the addressees to which the same e-mail was sent is therefore five. The number of addressees is determined by means of the field 302 of the first e-mail 300. The e-mail server 21 then sends a further e-mail for each of the persons 27 to 31 and sends it to the persons 27 to 31 before the persons 27 to 31 can call the first e-mail 300 from the e-mail server 21 and read it using one of the computers 22 to 26 (step 4 of the flowchart). FIG. 4 shows in an exemplary and schematic view one e-mail 400 of these further e-mails, which is sent to the person 27. By means of this further e-mail 400 the person 27 is informed that a possibly undesired e-mail, that is to say the first e-mail 300 which was sent by the person 33 has arrived for him at the e-mail server 21 and can be called. The further e-mail 400 also comprises information on the person 33 and the number of addressees of the first e-mail 300. Each of the persons 27 to 31 can then decide whether or not he wishes to read the first e-mail 300 addressed to him (step 5 of the flowchart).

In the case of the present exemplary embodiment, the persons 28 to 31 decide that they do not wish to read the first e-mail 300 addressed to them. Then they use the computer mouse of that of the computers 22 to 26 which they are currently using to click on the phrase “do not read” of that further e-mail 400 which was automatically sent to each of them by the e-mail server 21, after which the first e-mail 300 which was intended for them is deleted by the e-mail server 21 (step 6 of the flowchart) . However, the person 27 would like to read the first e-mail 300 which is intended for him, in which case he clicks on the word “read” of the e-mail 400.

Then, in the case of the present exemplary embodiment, the e-mail server 21 automatically calculates the number of further e-mails which have been sent by an external computer within the last 24 hours and have the same reference (step 7 of the flowchart). These further e-mails may have been sent to the same addressee or to different addressees and can also originate from different senders. If, in the case of the present exemplary embodiment, this number is greater than five, the e-mail server 21 automatically generates a further e-mail and sends it to this addressee (step 8 of the flowchart) . Otherwise, the e-mail which has arrived at the e-mail server 21 is passed on directly to the addressee who can then read this e-mail.

In the case of the present exemplary embodiment, the person 33 respectively sent ten further e-mails within 24 hours to the person 27, and said e-mails had the same reference as that of the first e-mail 300 sent to the person 27. The number of further e-mails which have arrived at the e-mail server 21 within the last 24 hours and which have the same reference as that of the first e-mail 300 and are intended for the person 27 is therefore ten. The e-mail server 21 then automatically generates a further e-mail 500 which is shown in FIG. 5 and which is automatically sent to the person 27.

By means of the e-mail 500, the person 27 is once more informed that a possibly undesired e-mail, that is to say the first e-mail 300 sent by the person 33, has arrived for him at the e-mail server 21. The e-mail 500 also comprises information on the reference of the first e-mail 300, on the person 33 and the number of further e-mails with the same reference which have arrived at the e-mail server 21 for the person 27 within the last 24 hours. The person 27 can then decide whether or not he wishes to read the first e-mail 300 which is addressed to him (step 9 of the flowchart).

In the case of the present exemplary embodiment, the person 27 decides that he does not wish to read the first e-mail 300 addressed to him after all. Then, said person 27 clicks on the phrase “do not read” of the e-mail 500, after which the first e-mail 300 intended for him is deleted by the e-mail server 21 before the person 27 opens this first e-mail 300, that is to say before this first e-mail 300 can cause damage (step 10 of the flowchart)

However, if the person 27 nevertheless wishes to read the first e-mail 300, he clicks on the word “read” of the e-mail 500, after which the first e-mail 300 is passed on to the computer of the computers 22 to 26 which the person 27 is currently using. The person 27 can then open the first e-mail 300 and read it (step 11 of the flowchart).

If, in the case of the present exemplary embodiment, the number of addressees of an e-mail which has arrived at the e-mail server 21 and has been sent by an external computer is less than four (step 3 of the flowchart), the e-mail server 21 does not generate a further e-mail 400, but rather immediately automatically calculates the number of further e-mails which have been sent to the same addressee by an external computer within the last 24 hours and have the same reference (step 7 of the flowchart). If this number is greater than five, the e-mail server 21 again automatically generates a further e-mail in accordance with the e-mail 500 illustrated in FIG. 5 and sends it to the addressee. Otherwise, the e-mail server 21 passes on this e-mail directly to the addressee.

Because in the case of the present exemplary embodiment the e-mail server 21 checks only e-mails which have been sent by external computers, such as the computer 31, e-mails which are sent by one of the computers 22 to 31 are not checked.

However, for the method according to the invention it is not necessary to check only external e-mails. The method according to the invention can also be used if there is no local computer network. It is then conceivable for a publicly accessible e-mail server, which is operated for example by a service provider, to carry out the method according to the invention.

Furthermore, for the method according to the invention it is also not absolutely necessary for the steps 3 and 7 of the flowchart to be carried out, that is to say for the e-mail server 21 to check the number of addressees to which the same e-mail is addressed and subsequently check the number of e-mails which have been sent to the same addressee or further addressees with the same reference within a predefined time. It is also possible to carry out only the step 3 or only the step 7 or only the step 7 and then the step 3 of the flowchart. For the step 7, it is also possible to check only the number of e-mails which have been sent to the same addressee within the predefined time period. However, it is also possible to use a different criterion for evaluating the first e-mail.

One criterion for detecting an undesired e-mail is for example, to check the checksum of the data record assigned to the field 303 and/or to check the checksum of the data record assigned to the field 304, of the first e-mail 300 shown in FIG. 3. The field 303 is assigned to the reference, and the field 304 is assigned to the actual message of the first e-mail 300. The checksum of one of these data records can be determined, for example, as follows.

The checksum is characterized in that basically a change of an individual bit in the entire data record changes the checksum. This is achieved in that all the bytes of a data record are summed.

The checksum can be determined, for example, with the following program routine which is executed in the BASIC programming language in the case of the present exemplary embodiment. In addition, it is assumed that the first e-mail 300 is transmitted in ASCII or in the expanded ASCII format.

FOR i=1 to data record length

CHECKSUM=MOD(CHECKSUM+ASC(MID$(DATA RECORD$,I,1)), 256)

NEXT i

END

The character number of the i-th character is therefore added to the previous checksum and subsequently subtracted from the newly determined checksum 256, if the newly determined checksum is greater than 256. The checksum is therefore a value between 1 and 256. As long as two data records are identical, their checksums are also identical. A higher degree of protection can be obtained by taking a higher power of two instead of 256.

It is possible easily to determine, for example, the number of identical e-mails on the basis of the determined checksums of the references and/or of the messages of e-mails which arrive at the e-mail server 21.

The values which are given in the exemplary embodiment and at which the e-mails 400 and 500 are generated, and the e-mails 400 and 500, are only exemplary in nature.

It is also the case that the computer network 20 does not necessarily have to be assigned to an industrial company. It may also be assigned, in particular, to an official authority, a university or a research institute.

1. A method for detecting an undesired e-mail, having the following method steps:
reception of a first e-mail (300) sent to an addressee (27-31) by means of an e-mail server (21),
automatic evaluation of the first e-mail (300) with at least one predetermined criterion, and
automatic generation and transmission of a second e-mail (400, 500), based on the evaluation of the first e-mail (300), to a computer (22-26) of the addressee (27-31) of the first e-mail (300) with a notification that there is a possibly undesired e-mail for the addressee (27-31), before the first e-mail (300) is passed on to the computer (22-26) of the addressee (27-31):

2. The method as claimed in claim 1, having the following additional method steps:
decision as to whether the addressee (27-31) of the first e-mail (300) would like to read the first e-mail on the basis of the notification of the second e-mail (27-31), and
passing on of the first e-mail (300) to the computer of the addressee if the latter would like to read the first e-mail, and automatic deletion of the first e-mail (300) if the addressee (22-27) would not like to read the first e-mail (300).

3. The method as claimed in one of claims 1 or 2, in which the criterion is a number of further addressees (27-31) to whom the first e-mail (300) is also addressed.

4. The method as claimed in one of claims 1 to 3, in which the criterion is a number of further e-mails which have been sent to the addressee (27-31) or further addressees (27-31) in a predefined time period and have the same reference (303) as the first e-mail (300).

5. The method as claimed in one of claims 1 to 4, in which the criterion is a number of further e-mails which have the same checksum of the data record of the reference (303) and/or of the message (304) as the first e-mail (300).

6. The method as claimed in one of claims 1 to 5, in which the first e-mail (300) is evaluated only if it has been sent by a computer (32) which is operated outside a local computer network (20), the local computer network (20) comprising the e-mail server (21) and the computer (22-26) of the addressee (27-31).

7. A device for detecting an undesired e-mail before an addressee (27-31) of the undesired e-mail reads the undesired e-mail, having
an e-mail server (21) and
a computer (27-31) which is connected to the e-mail server (21), for the purpose of reading e-mails which are intended for the addressee (27-31),
the e-mail server (21) being embodied in such a way that it evaluates a first e-mail (300) sent to the addressee (27-31), with at least one predetermined criterion, automatically generates a second e-mail (400, 500) on the basis of the evaluation of the first e-mail (300) and sends said second e-mail (400, 500) to the computer (22-26) of the addressee (27-31) of the first e-mail (300) before it passes on the first e-mail (300) to the computer (22-26) of the addressee (27-31), the second e-mail (400, 500) comprising a notification that there is a possibly undesired e-mail for the addressee (27-31).

8. The device as claimed in claim 7, in which, on the basis of a message, the e-mail server (21) passes on the first e-mail (300) to the computer of the addressee in response to the second e-mail (400, 500) if said addressee would like to read the first e-mail, and automatically deletes the first e-mail (300) if the addressee (22-27) would not like to read the first e-mail (300).

9. The device as claimed in one of claims 7 or 8, in which the criterion is a number of further addressees (27-31) to which the first e-mail (300) is also addressed.

10. The device as claimed in one of claims 7 or 8, in which the criterion is a number of further e-mails which have been sent to the addressees (27-31) or further addressees (27-31) in a predefined time period and have the same reference (303) as the first e-mail (300).

11. The device as claimed in one of claims 7 to 9, in which the criterion is a number of further e-mails which have the same checksum of the data record of the reference (303) and/or of the message (304) as the first e-mail (300).

12. The device as claimed in one of claims 7 to 11, in which the e-mail server (21) and the computer (22-26) of the addressee (27-31) form a local computer network (20), and the first e-mail (300) is evaluated only if it has been sent by a computer (32) which is operated outside the local computer network (20).

13. An e-mail server which passes on e-mails which have been sent to an addressee (27-31) to a computer (22-26) of the addressee (27-31),
a computer program which evaluates a first e-mail (300) sent to the addressee (27-31), with at least one predetermined criterion, running on the e-mail server, and
the e-mail server (21) automatically generating a second e-mail (400, 500) on the basis of the evaluation of the first e-mail (300) and sending said second e-mail (400, 500) to the computer (22-26) of the addressee (27-31) of the first e-mail (300), before it passes on the first e-mail (300) to the computer (22-26) of the addressee (27-31), the second e-mail (400, 500) comprising a notification that there is a possibly undesired e-mail for the addressee (27-31).

14. The e-mail server as claimed in claim 13, in which, on the basis of a message, the e-mail server (21) passes on, in response to the second e-mail (400, 500), the first e-mails (300) to the computer of the addressee if the latter would like to read the first e-mail, and automatically deletes the first e-mail (300) if the addressee (22-27) would not like to read the first e-mail (300).

15. The e-mail server as claimed in one of claims 13 or 14, in which the criterion is a number of further addressees (27-31) to which the first e-mail (300) is also addressed.

16. The e-mail server as claimed in one of claims 13 to 15, in which the criterion is a number of further e-mails which have been sent to the addressee (27-31) or further addressees (27-31) in a predefined time period, and have the same reference (303) as the first e-mail (300).

17. The e-mail server as claimed in one of claims 13 to 16, in which the criterion is a number of further e-mails which have the same checksum of the data record of the reference (303) and/or of the message (304) as the first e-mail (300).

18. The e-mail server as claimed in one of claims 13 to 17, in which the first e-mail (300) is evaluated only if it has been sent by a computer (32) which is operated outside a local computer network (20), the local computer network (20) comprising the e-mail server (21) and the computer (22-26) of the addressee (27-31).
